(19) United States
(12) Patent Application Publication
(10) Pub. No.: US 2008/0023533 A1
(43) Pub. Date: Jan. 31, 2008

(54) PACKING BOX AND FABRICATING BOARD THEREOF

(75) Inventor: Pi-Chun Chang, Taoyuan County (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: BENQ CORPORATION, Taoyuan Shien (TW)

(21) Appl. No.: 11/775,264

(22) Filed: Jul. 10, 2007

(30) Foreign Application Priority Data
Jul. 26, 2006 (TW) 95127329

(51) Int. Cl. B65D 5/462; B31B 3/26

(52) U.S. Cl. 229/143; 229/117.14; 229/141; 493/52

(57) ABSTRACT

A packing box comprising four top boards and a case body is provided. Two top boards respectively have a slot and a gripping board. Another two top boards respectively have a plugging board and a slit. The case body has an opening and four upper edges that are sequentially connected to the four top boards. The two top boards that respectively have the slot and the gripping board are firstly folded to cover the opening. Next, the other two top boards are folded for being disposed upon the original two top boards. Then, the gripping boards can pass through the slits and are protruded above the top boards. Afterwards, the plugging boards can be inserted into the slots for fixing the handle.

This application claims the benefit of Taiwan application Serial No. 95127329, filed Jul. 26, 2006 the subject matter of which is incorporated herein by reference.

### BACKGROUND OF THE INVENTION

1. Field of the Invention

The invention relates in general to a packing box and a fabricating board thereof, and more particularly to a packing box that has a case body and a handle and is folded by a fabricating board.

2. Description of the Related Art

Normally, an electronic product, such as a home appliance or a computer product for example, is received in a packing box during delivery. The packing box normally has a plastic handle and a case body. The case body is for protecting the electronic product and the handle provides convenience for users to carry by hand. However, the assembly of the case body and the plastic handle are time-consuming and requires more materials. Such design cannot be used for reducing the number of parts nor satisfying the requirement of green product.

A packing box for electric pot is disclosed in Taiwanese Patent Publication No. 82210043. The packing box for the electric pot folded by a single sheet of fabricating board has a handle and a buffer pad. The buffer pad provides a buffer function to protect the electric pot. Despite the packing box for the electric pot has a handle, it is required larger proportion of the area of the fabricating board to form the top boards, such that more cost is incurred to the fabricating board. Consequently, the cost of the packing box cannot be reduced down.

### SUMMARY OF THE INVENTION

The invention is directed to a packing box and fabricating board thereof. The packing box having a case body and a handle is folded by a fabricating board that is cut from a single sheet. The handle can be received inside the case body to save the space during delivery. The packing box is easily assembled and is economic in terms of storage space. Furthermore, the fabricating board is recyclable and is in conformity with the requirements of green product design.

According to a first aspect of the present invention, a packing box comprising a first, a second, a third, a fourth top boards and a case body is provided. The first top board has a first slot and a first gripping board. The second top board has a second slot and a second gripping board. The third top board has a first plugging board and a first slit. The fourth top board has a second plugging board and a second slit. The case body has an opening and are connected to the first, the second, the third, and the fourth top boards. The first and the second top boards are folded to cover part of the opening, and the third and the fourth top boards are folded to be disposed above the first and the second top boards. The first and the second gripping boards pass through the first and the second slits and are protruded above the third and the fourth top boards. Afterwards, the first and the second plugging boards are inserted into the first and the second slots.

According to a second aspect of the present invention, a fabricating board folded to form a packing box is provided. The fabricating board comprises a first pair of side boards, a second pair of side boards, a first pair of top boards, and a second pair of top boards. The first pair of side boards are alternated and connected with the second pair of side boards. The first pair of top boards is connected to the first pair of side boards. The second pair of top boards is connected to the second pair of side boards. The first pair of top board has a first top board and a second top board. The first top board has a first slot and a first gripping board. The second top board has a second slot and a second gripping board. The second pair of top boards has a third top board and a fourth top board. The third top board has a first plugging board and a first slit. The fourth top board has a second plugging board and a second slit. The first and the second plugging boards are used for being inserted into the first and the second slots of the first and the second top boards.

The invention will become apparent from the following detailed description of the preferred but non-limiting embodiments. The following description is made with reference to the accompanying drawings.

### BRIEF DESCRIPTION OF THE DRAWINGS

FIG. 1 is an expansion diagram of a packing box according to a preferred embodiment of the invention;

FIGS. 2A-2F are diagrams of assembling the fabricating board of FIG. 1 to form a packing box;

FIGS. 3A-3C are diagrams of assembling a packing box for delivery according to the fabricating board of FIG. 1.

### DETAILED DESCRIPTION OF THE INVENTION

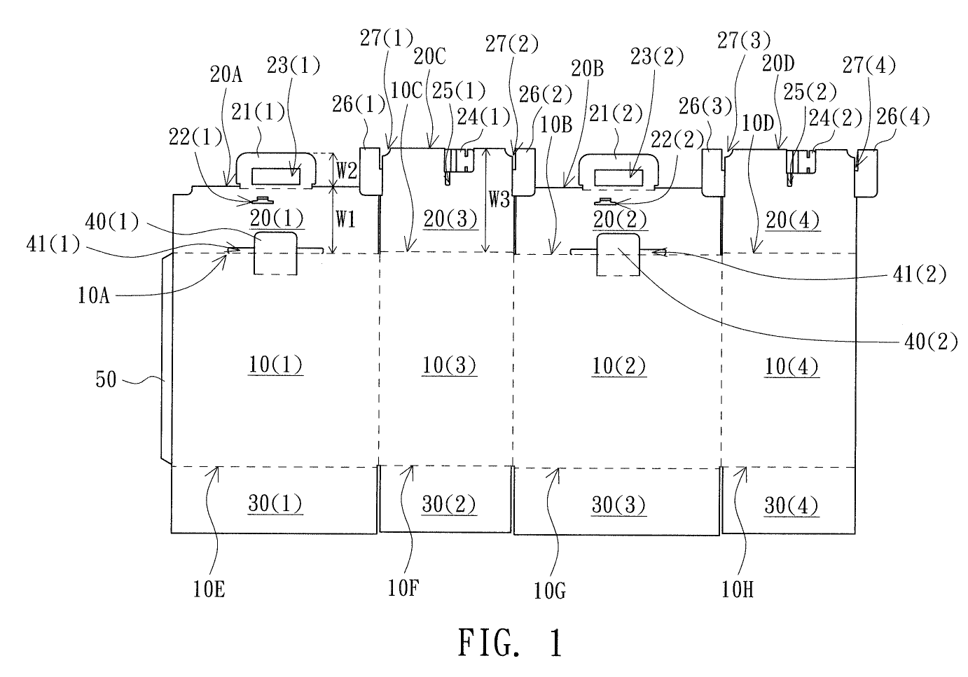

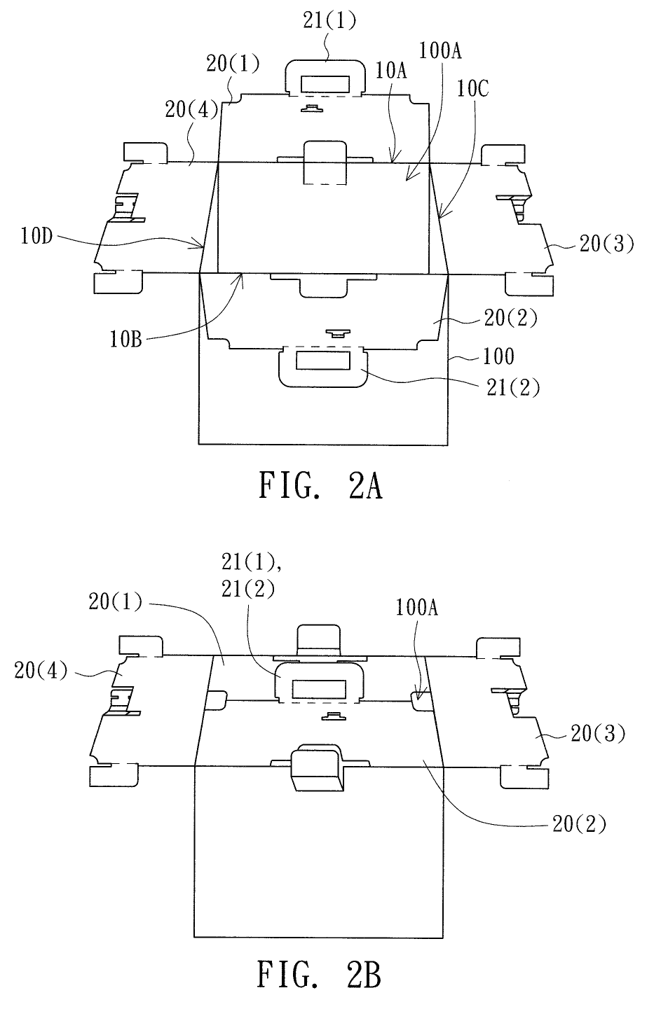

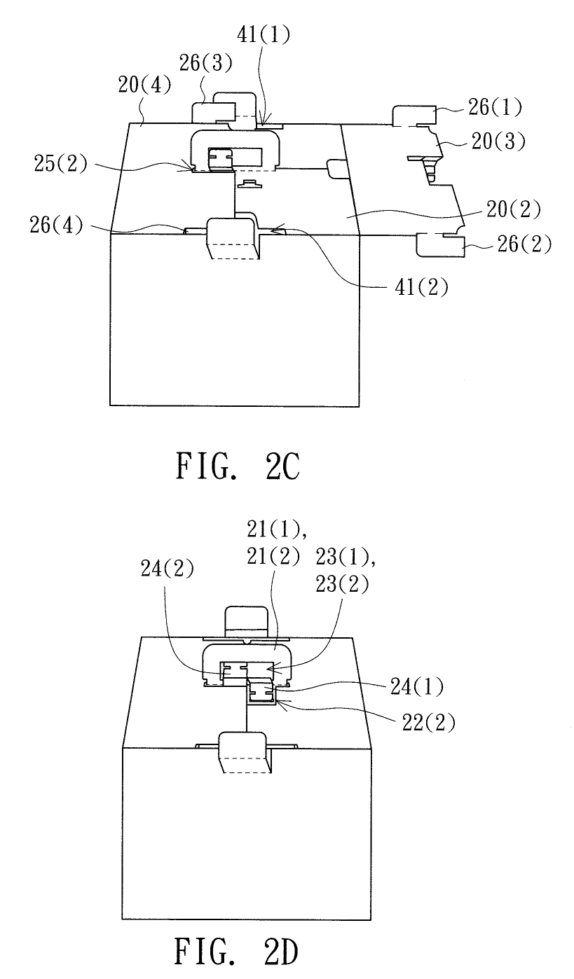

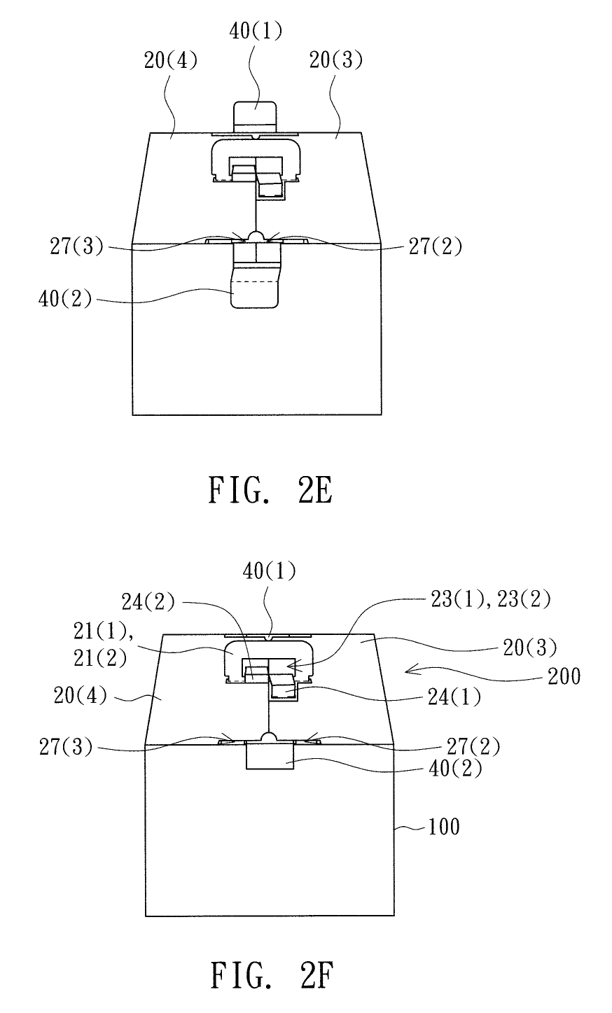

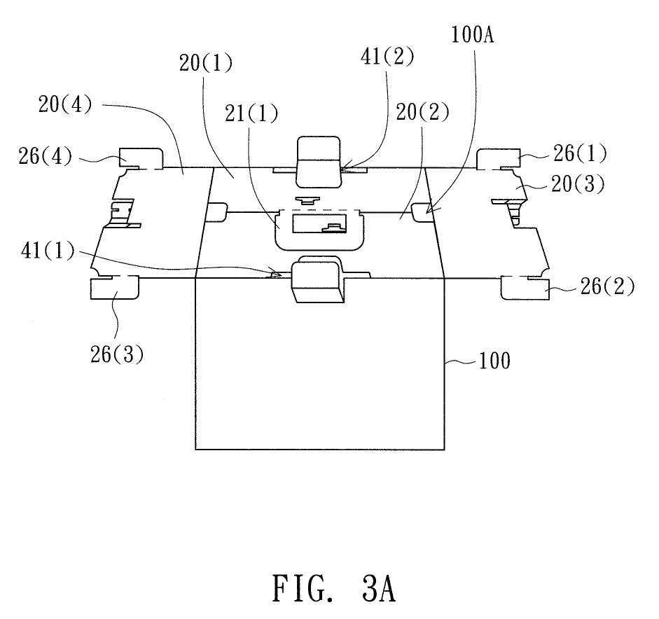

Please refer to FIG. 1 and FIG. 2A. FIG. 1 is an expansion diagram of a packing box according to a preferred embodiment of the invention. FIG. 2A is a diagram of assembling the fabricating board of FIG. 1 to form a packing box. As indicated in FIG. 1, the fabricating board 1 folded to form a packing box comprises a first pair of side boards, a second pair of side boards, a first pair of top boards, and a second pair of top boards. The first pair of side boards includes a first side board 10(1) and a second side board 10(2). The second pair of side boards includes a third side board 10(3) and a fourth side board 10(4). The first pair of top boards includes a first top board 20(1) and a second top board 20(2). The second pair of top boards includes a third top boards 20(3) and a fourth top board 20(4). The fabricating board 1 also comprises four bottom boards 30(1)˜30(4). The side boards 10(1), 10(3), 10(2), and 10(4) are sequentially connected. The first top board 20(1) and the second top board 20(2) are respectively connected to the upper edges 10A and 10B of the first side boards 10(1) and the second side board 10(2). The first top board 20(1) has a first gripping board 21(1) and a first slot 22(1). The second top board 20(2) has a second gripping board 21(2) and a second slot 22(2). The first gripping board 21(1) and the second gripping board 21(2) are respectively connected to the upper edges 20A and 20B of the first top boards 20(1) and the second top board 20(2). The first gripping board 21(1) and the second gripping board 21(2) have a first hole 23(1) and a second hole 23(2), respectively. The third top boards 20(3) and the fourth top board 20(4) are respectively connected to the upper edges 10C and 10D of the third side board 10(2) and the fourth side board 10(4). The third top board 20(3) has a first plugging board 24(1) and a first slit 25(1). The fourth top board 20(4) a second plugging boards 24(2) and a second slit 25(2). The first plugging board 24(1) and the second plugging board 24(2) are respectively connected to the upper edges 20C and 20D of the third top board 20(2) and the fourth top board 20(4). The four bottom boards 30(1)˜30(4) are respectively connected to the lower edges 10E˜10H of the first, the third, the second, and the fourth side boards 10(1), 10(3), 10(2) and 10(4). The bottom boards 30(1)˜30(4) and the side boards 10(1)˜10(4) are folded to form a case body 100 having an opening 100A as illustrated in FIG. 2A.

As indicated in FIG. 1, preferably, the first gripping board 21(1) and the second gripping board 21(2) are respectively connected to the central parts of the upper edges 20A and 20B of the first top boards 20(1) and the second top board 20(2), and the first slot 22(1) and the second slot 22(2) are respectively positioned near the central parts of the upper edges 20A and 20B of the first top boards 20(1) and the second top board 20(2). Furthermore, the third top board 20(3) further comprises two third plugging boards 26(1), 26(2), and two third slits 27(1), 27(2). The fourth top board 20(4) further comprises two fourth plugging boards 26(3), 26(4), and two fourth slits 27(3), 27(4). The slits 27(1)˜27(4) are substantially parallel to the slits 25(1) and 25(2).

Preferably, the fabricating board 1 further comprises a first tongue 40(1), a second tongue 40(2), a first buttonhole 41(1), and second buttonhole 41(2). The first buttonhole 41(1) is positioned at the center of the connection part of the first side boards 10(1) and the first top board 20(1). The second buttonhole 41(2) is positioned at the center of the connection part of the second top boards 20(2) and the second side board 10(2). The first buttonhole 41(1) and the second buttonhole 41(2) are substantially parallel to the lower edges of the first top board 20(1) and the second top board 20(2). The first tongue 40(1) and the second tongue 40(2) are respectively connected to the first side board 10(1) and the second side board 10(2) and extended towards the first top board 20(1) and the second top board 20(2). The connection part of the first tongue 40(1) and the first side board 10(1) and the connection part of the second tongue 40(2) and the second side board 10(2) are positioned underneath the first buttonhole 41(1) and the second buttonhole 41(2) respectively.

Preferably, the fabricating board 1 has a connecting board which can be connected to the side edge of the first side board 10(1) or the side edge of the fourth side board 10(4). In the present embodiment of the invention, a connecting board 50 is connected to the side edge of the first side board 10(1) for illustration. When the fabricating board 1 is folded to form a packing box, the connecting board 50 functions as a connecting interface between the first side board 10(1) and the fourth side board 10(4).

The fabricating board 1 of FIG. 1 can be assembled in two different ways to satisfy the needs of storage, delivery or carrying-by-hand. When a product is packed for delivery, the first gripping board 21(1) and the second gripping board 21(2) of the packing box are not exposed outside the case body; that is, the packing box is packed as an ordinary box for the convenience of storage or delivery. Alternatively, the first gripping board 21(1) and the second gripping board 21(2) can be folded to protrude from the case body to form a handle for the convenience of the user's portability. The process for folding the fabricating board 1 to form a packing box with a handle is disclosed below.

Referring to FIGS. 2A˜2F, diagrams of assembling the fabricating board of FIG. 1 to form a packing box are shown. As indicated in FIG. 2A, after four side boards 10(1)˜10(4) and four bottom boards 30(1)˜10(4) are folded to form a case body 100 that has an opening 100A. The first top board 20(1), the second top board 20(2), the third top boards 20(3), and the fourth top board 20(4) are respectively connected to the four upper edges 10A˜10D of the case body 100. Next, after the first and the second top boards 20(1) and 20(2) are folded towards the opening 100A to cover the opening 100A, the first and the second gripping boards 21(1) and 21(2) are respectively folded away from the opening 100A, then the two gripping boards 21(1) and 21(2) are possible to be against with each other as indicated in FIG. 2B.

Then, the third and the fourth top boards 20(3) and 20(4) are folded towards the opening 100A to cover the first and the second top boards 20(1) and 20(2). The fourth top board 20(4) covers a part of the first and the second top boards 20(1) and 20(2), as indicated in FIG. 2C, the first and the second gripping boards 21(1) and 21(2) pass through the second slit 25(2). Likewise, the third top board 20(3) covers a part of the first and the second top boards 20(1) and 20(2). Meanwhile, the third and the fourth plugging boards 26(1)˜26(4) disposed on the side edges of the third and the fourth top boards 20(3) and 20(4) are inserted into the first and the second buttonholes 41(1) and 41(2). As indicated in FIG. 2D, the first and the second gripping boards 21(1) and 21(2) are protruded from the surface of the top boards to form a handle.

Next, the first and the second plugging boards 24(1) and 24(2) respectively pass through the first and the second holes 23(1) and 23(2) located on the first and the second gripping board 21(1) and 21(2), and are inserted into the first and the second slots 22(2) and 22(1) (not illustrated in FIG. 2D) for fixing the handle formed by the first and the second gripping boards 21(1) and 21(2) as indicated in FIG. 2E.

Afterwards, the first tongue 40(1) is inserted into the third slit 27(1) and the fourth slit 27(4) (not illustrated in FIG. 2E) located on the third top board 20(3), the tongue second 40(2) is inserted into the third slit 27(2) and the fourth slit 27(3) located on the fourth top board 20(4). The assembly of the packing box is completed here. The assembled packing box is illustrated in FIG. 2F. The packing box 200 has a case body 100 and a handle formed by the first and the second gripping boards 21(1) and 21(2). Via the combination of the first and the second plugging boards 24(1) and 24(2), the third and the fourth plugging boards 26(1)˜26(4) (not illustrated in FIG. 2F), the first and the second tongues 40(1) and 40(2), and the first and the second top boards 20(1) and 20(2) (not illustrated in FIG. 2F), 20(3), 20(4) and the case body 100, the top boards are firmly connected to the case body 100, and the gripping boards 21(1) and 20(2) also form a stable handle. When a user would like to carry the packing box 200, the user can let his or her fingers pass through the first and the second holes 23(1) and 23(2) and grasp the gripping boards 21(1) and 21(2).

Moreover, when the product is to be delivered, the packing box is assembled in a manner that the first and the second gripping boards 21(1) and 21(2) are not exposed outside the case body 100 for the convenience of storage or delivery. Such way of assembling the packing box is disclosed below.

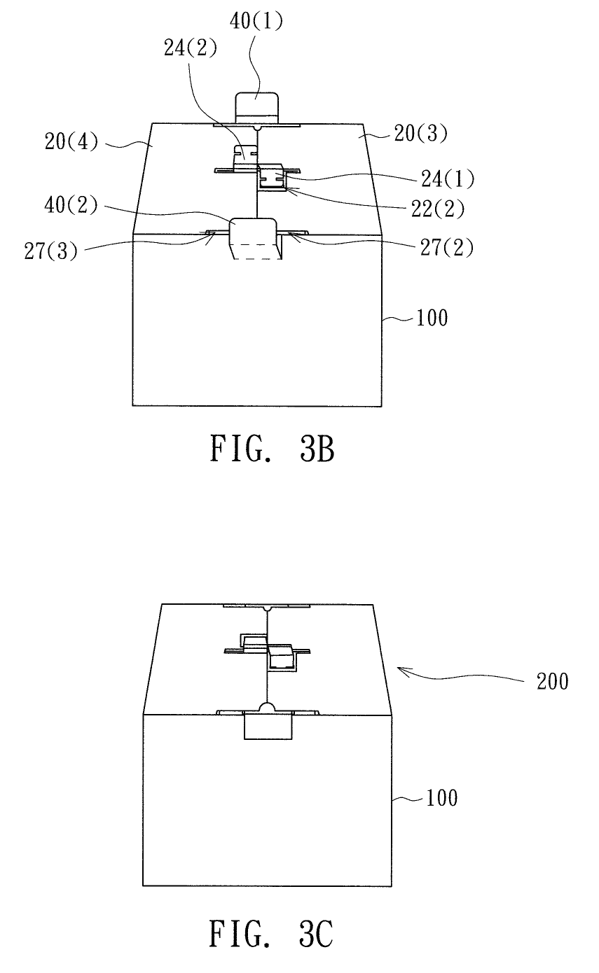

Referring to FIGS. 3A˜3C, diagrams of assembling a packing box for delivery according to the fabricating board of FIG. 1 are shown. As indicated in FIG. 3A, when the first and the second top boards 20(1) and 20(2) are respectively folded towards the opening 100A, the first and the second gripping boards 21(1) and 21(2) disposed on the first and the second top board 20(1) and 20(2) are also folded towards the opening 100A. Meanwhile, the second gripping board 21(2) (not illustrated in FIG. 3A) is disposed within the case body 100 below the first top board 20(1), and first gripping board 21(1) is flatly disposed above the top surface of the second top board 20(2).

Next, the third top board 20(3) and the fourth top board 20(4) are folded towards the opening 100A to cover the first and the second top boards 20(1) and 20(2), and all of the third and the fourth plugging boards 26(1)˜26(4) are inserted into the first and the second buttonholes 41(1) and 41(2). Meanwhile, as indicated in FIG. 3B, after the first and the second plugging boards 24(1) and 24(2) are inserted into the first and the second slots 22(1) and 22(2) (the first slot 22(1) is not illustrated in FIG. 3B) and after the first tongues 40(1) is inserted into the third and the fourth slits 27(1), 27(4) (the slit 27(1) and 27(4) are not illustrated in FIG. 3B) and the second tongue 40(2) is inserted into the third and the fourth slits 27(2), 27(3), the top boards 20(3) and 20(4) are fixed onto the case body 100. As the assembled packing box 200 shown in FIG. 3C, the gripping boards 21(1) and 21(2) are not exposed outside the case body.

If a packing box is used for the purpose of delivery, the gripping boards are not exposed outside the case body. As a result, not only the delivery space is reduced, and the transportation volume of a container and the storage capacity of a warehouse are also increased.

The fabricating board 1 of FIG. 1 can be assembled in two different ways to meet the needs of storage, delivery or carrying-by-hand. The design of the fabricating board 1 also has the advantage of saving materials to be used. For example, the first and the second top boards 20(1) and 20(2) substantially have the same first width W1; the gripping boards 21(1) and 21(2) substantially have the same second width W2; the third and the fourth top boards 20(3) and 20(4) substantially have the same third width W3. Preferably, the sum of the first width W1 and the second width W2 is substantially equal to or smaller than the third width W3. The cost for the fabricating board is based on the area formed by the maximum length and the maximum width when the fabricating board is completely expanded. The design of the gripping boards 21(1) and 21(2) of the invention does not increase the entire expanded area of the fabricating board; therefore, there is no increment to the cost of the fabricating board. Compared with the packing box for electric pot disclosed in Taiwanese Patent Publication No. 82210043, the packing box of the invention is further advantaged by material saving of fabricating board.

According to the packing box and fabricating board thereof disclosed in the above embodiment of the invention, the packing box has a case body and a handle which is not exposed outside the case body for saving the space occupied by the portable packing box during storage or delivery. After the product is sold, the handle can be folded to expose outside the case body, so that the user or the consumer can carry the box by the handle. Compared with the conventional packing box having a plastic handle, the fabricating board for being folded to form the packing box is cut from a single sheet, hence dispensing with the use of plastic handle, such that the time and labor required for fixing the handle to the fabricating board are also omitted. Consequently, both the cost and the number of components to be assembled are reduced. The recyclability of the fabricating board makes the packing box more environmental friendly and satisfactory to the market needs.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A packing box comprising:
a first top board having a first slot and a first gripping board;
a second top board having a second slot and a second gripping board;
a third top board having a first plugging board and a first slit;
a fourth top board having a second plugging board and a second slit; and
a case body having an opening, the case body are connected to the first, the second, the third and the fourth top boards;
wherein the first and the second top boards being folded to cover part of the opening, the third and the fourth top boards being folded to be disposed above the first and the second top boards, and the first and second gripping boards passing through the first and the second slits and protruded above the third and the fourth top boards, and the first and second plugging boards being respectively inserted into the first and the second slots.

2. The packing box according to claim 1, wherein the first gripping board has a first hole and the second gripping board has a second hole, when the first and second gripping boards are protruded above the third and the fourth top boards, the first and the second gripping boards, the first and the second holes jointly form a handle.

3. The packing box according to claim 2, wherein and the first and the second plugging boards pass through the first and the second holes and are respectively inserted into the first and the second slots.

4. The packing box according to claim 1, wherein the packing box is formed by a single fabricating board that cut from a single sheet.

5. The packing box according to claim 1, wherein the case body comprises a first side board, a second side board, a third side board, and a fourth side board connecting to the first, the second, the third, and the fourth top boards respectively.

6. The packing box according to claim 5, wherein the case body comprises four bottom boards connected to the first, the second, the third, and the fourth side boards respectively.

7. The packing box according to claim 5, wherein a first connection portion of the first side board and the first top board has a first buttonhole parallel to a lower edge of the first top board, the first side board has a first tongue extended towards the first top board, and a part of the first tongue is located underneath the first buttonhole.

8. The packing box according to claim 7, wherein a second connection portion of the third side board and the third top board has a second buttonhole parallel to a lower edge of the third top board, the third side board has a second tongue extended towards the third top board, and a part of the second tongue is located underneath the second buttonhole.

9. The packing box according to claim 1, wherein the third top board has a third plugging board and a third slit substantially parallel to the first slit, and the fourth top board has a fourth plugging board and a fourth slit substantially parallel to the second slit.

10. The packing box according to claim 1, wherein the first and the second gripping boards are respectively located at the central parts of upper edges of the first and the second top boards, and the first and the second slots are respectively positioned near the central parts of the upper edges of the first and the second top boards.

11. The packing box according to claim 1, wherein the first and the second top boards substantially have the same first width, the first and the second gripping boards substantially have the same second width, the third and the fourth top boards substantially have the same third width, the sum of the first width and the second width is substantially equal to the third width.

12. A fabricating board for being folded to form a packing box, the fabricating board comprising:
a first pair of side boards having a first side board and a second side board;
a second pair of side boards having a third side board and a fourth side board that are alternated and connected with the first pair of side boards;
a first pair of top boards having a first top board and a second top board that are connected to the first and the second side boards respectively, the first top board having a first slot and a first gripping board, the second top board having a second slot and a second gripping board; and
a second pair of top boards having a third top board and a fourth top board that are connected to the third and fourth side boards respectively, the third top board having a first plugging board and a first slit, the fourth top board having a second plugging board and a second slit, the first and the second plugging boards dimensioned to be inserted into the first and the second slots of the first and the second top boards.

13. The fabricating board according to claim 12, wherein the first gripping board has a first hole and the second gripping board has a second hole to make the first and second gripping boards shaped as a handle.

14. The fabricating board according to claim 13, wherein the first and the second plugging boards pass through the first and the second holes when the fabricating board is folded and the first and the second plugging boards are respectively inserted into the first and the second slots.

15. The fabricating board according to claim 12, further comprises:
four bottom boards respectively connected to the the first, the second, the third, and the fourth side boards.

16. The fabricating board according to claim 12, wherein a first connection portion of the first side board and the first top board has a first buttonhole parallel to a lower edge of the first top board, and the first side board has a first tongue extended towards the first top board, and a part of the first tongue is located underneath the first buttonhole.

17. The fabricating board according to claim 16, wherein a second connection portion of the third side board and the third top board has a second buttonhole parallel to a lower edge of the third top board, the third side board has a second tongue extended towards the third top board, and a part of the second tongue is located underneath the second buttonhole.

18. The fabricating board according to claim 12, wherein the third top board has a third plugging board and a third slit substantially parallel to the first slit, and the fourth top board has a fourth plugging board and a fourth slit substantially parallel to the second slit.

19. The fabricating board according to claim 12, wherein the first and the second gripping boards are respectively located at the central parts of upper edges of the first and the second top boards, and the first and the second slots are respectively positioned near the central parts of the upper edges of the first and the second top boards.

20. The fabricating board according to claim 12, wherein the first and the second top boards substantially have the same first width, the first and the second gripping boards substantially have the same second width, the third and the fourth top boards substantially have the same third width, and the sum of the first width and the second width is substantially equal to the third width.
